(19) United States
(12) Patent Application Publication
(10) Pub. No.: US 2023/0065259 A1
(43) Pub. Date: Mar. 2, 2023

(54) METHOD AND APPARATUS FOR PROTECTING SMART CONTRACTS AGAINST ATTACKS

(71) Applicant: Shanghai Wormholes Tech Ltd., Shanghai (CN)

(72) Inventors: Ting Chen, Sichuan (CN); Gang Chen, Sichuan (CN); Taiyong Zhang, Shanghai (CN)

(21) Appl. No.: 17/794,516

(22) PCT Filed: Jan. 22, 2020
(86) PCT No.: PCT/CN2020/073736

§ 371 Date: Jul. 21, 2022

(51) Int. Cl. G06F 21/55

(52) U.S. Cl. CPC G06F 21/554; G06F 2221/034

(57) ABSTRACT

Methods and apparatuses of the disclosure provide a framework including a customized running environment and an analysis engine unit that can use runtime information from the running environment to identify known or unknown attacks to smart contracts on any blockchains and protect the smart contracts against the attacks. This general-purpose framework has low runtime overhead, reduced difficulty of developing analysis engine units, and improved response speed for new attacks.

### FIELD OF THE DISCLOSURE

The present disclosure relates generally to smart contracts on a blockchain, and more particularly, to a method and apparatus for protecting smart contracts on a blockchain against attacks.

### BACKGROUND

Smart contracts are autonomous programs that execute the predefined logic automatically and mandatorily between mutually distrusting participants, which are automatically enforced by the consensus mechanism of the blockchain without relying on a trusted authority. The rise of smart contract systems such as Ethereum has resulted in a proliferation of blockchain-based decentralized applications including applications that store and manage a wide range of data. The fact that smart contracts are executed correctly is a necessary condition for their effectiveness: otherwise attacks on the contracts (e.g., due to any functional bugs, vulnerabilities etc.) can lead to disastrous losses such as severe financial loss. Improving robustness of smart contracts is thus a pressing practical problem.

Conventionally, there are two categories of approaches to improve the security of smart contracts: offline analysis and online protection. Offline analysis approaches analyze smart contracts, including vulnerability discovery, correctness check, reverse engineering and detection of malicious smart contracts before contract deployment. Online protection aims to protect smart contracts against attacks after the deployment of smart contracts. Online protection approaches either insert runtime checks into smart contracts, or into the runtime environment (e.g., VM (virtual machine) such as EVM (Ethereum VM)) of smart contracts.

### SUMMARY OF THE DISCLOSURE

In a first exemplary aspect of the disclosure, a computer implemented method for protecting a smart contract against attacks is provided. The method includes: detecting a first operation related to a smart contract on a blockchain, that is initiated in a running environment; obtaining runtime information as raw data, associated with the first operation after the first operation is detected; generating analytical data associated with the security of the smart contract resulting from activities of the first operation, based on the runtime information; and initiating a second operation related to the security of the smart contract, based on the analytical data.

In a second exemplary aspect of the disclosure, an apparatus for protecting a smart contract against attacks is provided. The apparatus includes: a detecting unit configured to detect a first operation related to a smart contract on a blockchain, that is initiated in a running environment; an information collecting unit configured to obtain runtime information as raw data, associated with the first operation after the detecting unit detects the first operation; an analysis engine unit configured to generate analytical data associated with the security of the smart contract resulting from activities of the first operation, based on the runtime information; and a responding unit configured to initiate a second operation related to the security of the smart contract, based on the analytical data.

In a third exemplary aspect of the disclosure, an apparatus for protecting a smart contract against attacks is provided. The apparatus includes: means for detecting a first operation related to a smart contract on a blockchain, that is initiated in a running environment; means for obtaining runtime information as raw data, associated with the first operation after the first operation is detected; means for generating analytical data associated with the security of the smart contract resulting from activities of the first operation, based on the runtime information; and means for initiating a second operation related to the security of the smart contract, based on the analytical data.

In some embodiments of the method and apparatus described above, the runtime information may be obtained from a kernel layer and an application layer of the running environment.

Some embodiments of the method and apparatus described above may include processes, features or means for analyzing the runtime information according to a set of rules to generate the analytical data.

Some embodiments of the method and apparatus described above may also include processes, features or means for extracting activity characteristics of the first operation from the runtime information and analyzing the activity characteristics according to the set of rules to generate the analytical data, the set of rules being related to at least one of execution orders, the number of executions, and execution parameters.

Further, some embodiments of the method and apparatus described above may include processes, features or means for determining contents of the runtime information that are required to generate the analytical data and obtaining the runtime information based on the determined contents.

Moreover, some embodiments of the method and apparatus described above may include processes, features or means for determining grouping pattern of runtime information and groups of the runtime information that are required to generate the analytical data. Some embodiments of the method and apparatus described above may further include processes, features or means for obtaining and grouping the runtime information based on the determined grouping pattern and groups and generating the analytical data based on the grouped runtime information.

In some embodiments of the method and apparatus described above, the first operation may include at least one of creation, deployment, invocation and execution of the smart contract.

In further embodiments of the method and apparatus described above, the second operation may include at least one of: permission of one or more activities of the first operation; prevention of one or more activities of the first operation; and generation of a report for one or more activities of the first operation.

In further embodiments of the method and apparatus described above, the runtime information may include at least one of block information, transaction information and instruction information associated with the first operation.

In a fourth exemplary aspect of the disclosure, a computer implemented method for protecting a smart contract against attacks is provided. The method includes: detecting a first operation related to a smart contract on a blockchain, that is initiated in a running environment; obtaining runtime information as raw data, associated with the first operation after the first operation is detected; transmitting the runtime information to an analysis engine unit outside the running environment; receiving, from the analysis engine, analytical data associated with the security of the smart contract resulting from activities of the first operation; and initiating a second operation related to the security of the smart contract, based on the analytical data.

In a fifth exemplary aspect of the disclosure, an apparatus for protecting a smart contract against attacks is provided. The apparatus includes: a detecting unit configured to detect a first operation related to a smart contract on a blockchain, that is initiated in a running environment; an information collecting unit configured to obtain runtime information as raw data, associated with the first operation after the first operation is detected; a transmitter to transmit the runtime information to an analysis engine unit outside the running environment; a receiver to receive, from the analysis engine, analytical data associated with the security of the smart contract resulting from activities of the first operation; and a responding unit configured to initiate a second operation related to the security of the smart contract, based on the analytical data.

In a sixth exemplary aspect of the disclosure, an apparatus for protecting a smart contract against attacks is provided. The apparatus includes: means for detecting a first operation related to a smart contract on a blockchain, that is initiated in a running environment; means for obtaining runtime information as raw data, associated with the first operation after the first operation is detected; means for transmitting the runtime information to an analysis engine outside the running environment; means for receiving, from the analysis engine, analytical data associated with the security of the smart contract resulting from activities of the first operation; and means for initiating a second operation related to the security of the smart contract, based on the analytical data.

In some embodiments of the method and apparatus described above, the runtime information may be obtained from a kernel layer and an application layer of the running environment.

Some embodiments of the method and apparatus described above may include processes, features or means for obtaining a first message indicating contents of the runtime information that are required to be transmitted to the analysis engine unit and obtaining the runtime information based on the first message.

Further, some embodiments of the method and apparatus described above may include processes, features or means for obtaining a second message indicating grouping pattern of runtime information and groups of the runtime information that are required to be transmitted to the analysis engine unit. Further embodiments of the method and apparatus described above may also include processes, features or means for obtaining and grouping the runtime information based on the second message and transmitting the grouped runtime information to the analysis engine unit.

In some embodiments of the method and apparatus described above, the first operation may include at least one of creation, deployment, invocation and execution of the smart contract.

In further embodiments of the method and apparatus described above, the second operation may include at least one of: permission of one or more activities of the first operation; prevention of one or more activities of the first operation; and generation of a report for one or more activities of the first operation.

In further embodiments of the method and apparatus described above, the runtime information may include at least one of block information, transaction information and instruction information associated with the first operation.

In a seventh exemplary aspect of the disclosure, a computer implemented method for protecting a smart contract against attacks is provided. The method includes: receiving, from an interpreter in a running environment, runtime information as raw data, associated with a first operation that is initiated in the running environment and related to a smart contract on a blockchain; analyzing the runtime information according to a set of rules to generate analytical data associated with the security of the smart contract resulting from activities of the first operation; and transmitting the analytical data to the interpreter.

In an eighth exemplary aspect of the disclosure, an apparatus for protecting a smart contract against attacks is provided. The apparatus includes: a receiver configured to receive, from an interpreter in a running environment, runtime information as raw data, associated with a first operation that is initiated in the running environment and related to a smart contract on a blockchain; an analyzer configured to analyze the runtime information according to a set of rules to generate analytical data associated with the security of the smart contract resulting from activities of the first operation; and a transmitter configured to transmit the analytical data to the interpreter.

In a ninth exemplary aspect of the disclosure, an apparatus for protecting a smart contract against attacks is provided. The apparatus includes: means for receiving, from an interpreter in a running environment, runtime information as raw data, associated with a first operation that is initiated in the running environment and related to a smart contract on a blockchain; means for analyzing the runtime information according to a set of rules to generate analytical data associated with the security of the smart contract resulting from activities of the first operation; and means for transmitting the analytical data to the interpreter.

In some embodiments of the method and apparatus described above, the runtime information may be obtained from a kernel layer and an application layer of the running environment.

Some embodiments of the method and apparatus described above may include processes, features or means for extracting activity characteristics of the first operation from the runtime information and analyzing the activity characteristics according to the set of rules to generate the analytical data, the set of rules being related to at least one of execution orders, the number of executions, and execution parameters.

Further, some embodiments of the method and apparatus described above may include processes, features or means for transmitting to the interpreter a first message indicating contents of the runtime information that are required to be received from the interpreter.

Some embodiments of the method and apparatus described above may also include processes, features or means for transmitting to the interpreter a second message indicating grouping pattern of runtime information and groups of the runtime information that are required to be received from the interpreter.

In a tenth exemplary aspect of the disclosure, an apparatus for protecting a smart contract against attacks is provided. The apparatus includes: at least one processor; a memory comprising instructions, which when executed cause the at least one processor to implement a method according to the first, fourth and seventh exemplary aspects of the disclosure.

In an eleventh exemplary aspect of the disclosure, a computer readable storage medium is provided. The computer readable storage medium stores computer executable instructions for implementing a method according to the first, fourth and seventh exemplary aspects described above.

In a twelfth exemplary aspect of the disclosure, a computer program product tangibly stored in a computer readable storage medium is provided. The computer program product stores computer executable instructions, which when executed cause at least one processor to implement a method according to the first, fourth and seventh exemplary aspects described above.

### BRIEF DESCRIPTION OF THE DRAWINGS

FIG. 1 is a diagram illustrating an architecture for protecting smart contracts against attacks according to an embodiment of the disclosure.

FIG. 2 is a diagram illustrating another architecture for protecting smart contracts against attacks according to an embodiment of the disclosure.

FIG. 3 is a diagram illustrating another architecture for protecting smart contracts against attacks according to an embodiment of the disclosure.

FIG. 4 is a diagram illustrating another architecture for protecting smart contracts against attacks according to an embodiment of the disclosure.

FIG. 5 illustrates an example of an information collecting unit of FIGS. 1-2.

FIG. 6 is a flowchart illustrating a method for protecting smart contracts against attacks.

FIG. 7 is a flowchart illustrating another method for protecting smart contracts against attacks.

FIG. 8 is a flowchart illustrating another example method for protecting smart contracts against attacks.

FIG. 9 is a diagram illustrating an apparatus for protecting smart contracts against attacks.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Conventional offline analysis approaches analyze smart contracts before contract deployment to improve the security of smart contracts. However, offline methods suffer from two drawbacks. First, the smart contracts may also contain vulnerabilities after the process of offline tools. For instance, some symbolic-execution-based tools may not discover all bugs due to path explosion. As another example, some fuzzing tools are unlikely to reveal all vulnerabilities due to the low code coverage of black-box fuzzing. Lacking the runtime information is another reason for offline tools missing vulnerabilities (e.g., some unknown or novel runtime attacks). For example, some analysis tools fail to find certain kinds of reentrancy bugs because they lack the runtime information which includes interaction of functions, interaction of smart contracts, and the execution of the contract's constructor. Second, offline approaches cannot protect the smart contracts which have been deployed on the blockchain against attacks, because the blockchain technology guarantees that a smart contract is immutable after deployment.

Conventional online protection approaches either insert runtime checks into smart contracts, or into the running environment of smart contracts to improve the security of smart contracts. The former approach has two drawbacks. First, it can strengthen future smart contracts, while leaving already deployed (legacy) smart contracts unprotected. Second, the complexity of smart contracts is restricted by blockchain protocols (e.g., the gas mechanism designed by Ethereum) and therefore the protection capability (i.e., the complexity of the inserted code) is restricted. The latter approach can protect the smart contracts which have been deployed against attacks since all historical smart contracts run within the runtime environment. However, the customization of the runtime environment is difficult and time-consuming, because such customization needs deep understanding of blockchain internals and great code efforts, and is specific to a blockchain platform.

By contrast, by using runtime information as raw data, methods and apparatuses of the disclosure provide a framework including a customized running environment and an analysis engine unit that can use runtime information from the running environment to identify known or unknown attacks to smart contracts on any blockchains and protect the smart contracts against the attacks. This general-purpose framework has low runtime overhead, reduced difficulty of developing analysis engine units, and improved response speed for new attacks.

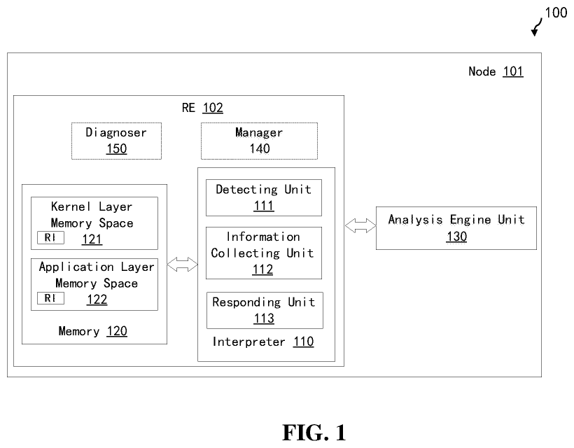

FIG. 1 is a diagram illustrating an architecture 100 for protecting smart contracts against attacks according to an embodiment of the disclosure. All and any part of the architecture 100 may be implemented by one or more nodes of a blockchain such as a node 101 (e.g., a full node of a blockchain) or any other devices. The node 101 includes a running environment (RE) 102 such as virtual machine (VM) (e.g., EVM) built for a blockchain and an analysis engine unit 130 (also called “protector”) outside the RE 102 (e.g., outside the kernel layer of the RE 102) for analyzing any potential attacks to a smart contract on a blockchain. While a single analysis engine unit is shown in FIG. 1, the architecture 100 may include multiple analysis engine units. In the example of FIG. 1, the RE 102 and the analysis engine unit 130 operate on the same node or device.

Since the analysis engine 130 is separate from the RE 102, the developers of analysis engine units do not need to understanding blockchain internals because they do not need to modify RE, and therefore developing analysis engine units based on the interpreter is much easier than developing from scratch. In an example, the analysis engine unit may be a dynamic link library (DLL) within the same process of the RE. Such design eliminates inter-process communication (IPC) between the RE with analysis engine units, thus improving the efficiency. It also enables analysis engine units to plug and play, and allows developers to choose any programming languages that can be compiled into DLL.

The RE 102 includes an interpreter 110, a memory 120, an optional manager 140 and an optional diagnose 150. The interpreter 110 is embedded in a lower layer of the RE 102 to obtain runtime information (RI) as raw data directly from the lower layer (e.g., kernel layer) and high layer (e.g., application layer) of RE 102. The interpreter 110 can obtain the RI from the memory 120 of RE 102 which includes a kernel layer memory space 121 for storing RI from the kernel layer and an application layer memory space 122 for storing RI from the application layer. The kernel layer memory space 121 and the application memory space 122 are segregated from each other. In other examples, the interpreter 110 may obtain RI as raw data from the lower layer (e.g., kernel layer) and high layers (e.g., application layer) of RE 102 indirectly via another storage or database that stores the RI. The manager 140 is responsible for registering and unregistering the analysis engine unit 130. The diagnoser 150 diagnoses or debugs a smart contract.

The interpreter 110 includes a detecting unit 111 for detecting the operation of smart contracts, an information collecting unit 112 for obtaining information of smart contracts and a responding unit 113 to take action (e.g., security action) according to the results of the analysis engine unit 130.

The detecting unit 111 detects a first operation related to one or more smart contracts on a blockchain, that is initiated in the RE 102. A user may visit the node 101 via a client to initiate an operation of a smart contract. For example, a user may visit the node 101 to make a deployment transaction by sending contract bytecode to an empty address, thus initiating a deployment of a smart contract. After the deployment of a smart contract, other users may visit the node 101 via a client to invoke the smart contract.

When a mining node includes the transaction in a block it generates, the execution for a smart contract transaction occurs. The smart contract code and transaction is re-run by every validating node upon receipt of the block.

Mining nodes may generate a block in the following cases:
Receive unconfirmed transactions from the network
Validate each unconfirmed transaction, including running associated code
Include valid transactions to fill the block

Once the block is generated, it's distributed to the network, and any node to receive that block then proceeds to run through the list of transactions, ensuring each transaction is valid.

And smart contract code may run at the following time:
Lots of times, repeatedly and redundantly, e.g., by design
But the “official” execution point is the point at which the transaction occurs in the blockchain. For example, if it's transaction #6 in block #8000000, then the transaction's “point of execution” could perhaps only be described as immediately following transaction #5, preceding transaction #7.

The repeated validation is possible because smart contract transactions are deterministic. They may depend on factors such as the block number itself, current storage values for a contract, or the result of another smart contract's computation, but that information is constant and can be recomputed perfectly by stepping through transactions from the start of the chain.

There are other examples of initiating an operation related to a smart contract, which are not described in detail for brevity.

The information collecting unit 112 obtains runtime information as raw data, associated with the first operation after the detecting unit 111 detects the first operation. By contrast, conventional online protection can only obtain runtime information from an application layer of the running environment, which is much less than that information from a kernel layer. For example, to perform an add operation such as c=a+b, runtime information from the application layer can only include an input data a, an input data b and an output data c, while runtime information as raw data can include the stack-based operations on memory as follows:

I2: LOAD b

I1: LOAD c

I3: ADD

I4: STORE a

In this example, the runtime information as raw data can provide more information (e.g., how data is pushed into and popped from the stack, etc.) than runtime information from the application layer.

The analysis engine unit 130 can retrieve the runtime information from the information collecting unit 112. The analysis engine unit 130 generates analytical data associated with the security of the smart contract resulting from activities of the first operation based on the runtime information. For example, the analytical data may indicate or be used to determine a severity level of any potential abnormal operation of the smart contract due to attacks which may come from an external source (e.g., an external invocation of the smart contract). One or more activities of the abnormal operation may for example lead to unsafe results on the blockchain.

The responding unit 113 can retrieve the analytical data from the analysis engine 130. The responding unit 113 initiates a second operation related to the security of the smart contract based on the analytical data. For example, according to the generated analytical data indicating a severity level of any potential abnormal operation of the smart contract due to attacks, the responding unit 113 can take respective security action to deal with the first operation related to the smart contract.

By using rich runtime information as raw data, the architecture 100 described above can provide a general-purpose framework to identify any potential abnormal operation due to attacks to smart contracts on any blockchains and take respective security action to protect the smart contract against attacks.

In a further embodiment, the information collecting unit 112 may obtain the runtime information from a kernel layer and an application layer of the runtime information. As described above, conventional online protection can only obtain runtime information from an application layer of the running environment.

In a further embodiment, the analysis engine unit 130 may analyze the runtime information according to a set of rules to generate the analytical data. The set of rules is dynamically configurable so that the analysis engine unit 130 can actively defend any known, unknown or novel attacks while conventional online protection can only passively defend known attacks because of its comparison of operation with known attacks.

In a further embodiment, the analysis engine unit 130 may extract activity characteristics of the first operation from the runtime information and analyze the activity characteristics according to the set of rules to generate the analytical data, wherein the set of rules may be related to at least one of execution orders, the number of executions, and execution parameters, etc. The activity characteristics of the first operation represent information related to one or more activities of the first operation, such as the number of function invocation, function parameters and input data of transaction.

As an example for the set of rules, a smart contract A has a loop and in each iteration, A invokes another smart contract B which calls back to A. A computer program or subroutine is referred to as “a reentrant function” if it can be interrupted in the middle of its execution and then safely be called again (“re-entered”) before its previous invocations complete execution. To eliminate a cycle which is not incurred by re-entrancy, a counter is maintained which increases when an internal transaction begins and decreases when an internal transaction ends. If the cycle is formed by re-entrancy, the counter will increase when the cycle iterates because the caller will wait the callee to finish. On the contrary, the counter will be reset when the loop starts a new iteration, because all internal transactions produced in a loop return. In this example, the analysis engine unit 130 extracts activity characteristics (e.g., the number of fallback function invocation) from the runtime information. By using rules related to the number of executions (e.g., times of a cycle), the analysis engine unit 130 can identify a cycle which executes many times and transfers resources (e.g., ETH), and generate the analytical data indicating a potential abnormal operation due to re-entrancy attacks. In this example, the analysis engine unit 130 needs transaction information, especially the addresses of the transaction sender and the transaction receiver, the resource to send, when the transaction starts and ends.

As another example for the set of rules, the bytecode of a smart contract contains a dispatch routine which reads the function ID from a transaction and determines which function will be invoked by matching the read function ID with the function ids encoded in the dispatch routine. If the read function ID does not match the encoded function IDs, the fallback function will be invoked. Such function invocation can be referred as “incorrect function invocation”, because the called function (i.e., the fallback function) is not the expected one (i.e., the function indicated by the transaction). The analysis engine unit 130 may detect an “incorrect function invocation” in three steps. In the first step, the analysis engine unit 130 processes the transaction information for deploying smart contracts, to get the bytecode of each deployed smart contract. After that, it locates the dispatch routine in the bytecode and obtains all function IDs encoded in the dispatch routine. Therefore, the analysis engine unit 130 maintains a dictionary which associates the address of a smart contract with the list of function IDs. In the second step, the analysis engine unit 130 processes the transaction information for invoking smart contract, to get the function ID which indicates the expected function to invoke. In the third step, for each function invocation, the analysis engine unit 130 checks whether the function ID extracted from the input data belongs to the list of function IDs maintained in the dictionary. If not, an “incorrect function invocation” is detected. The analysis engine unit 130 can be further enhanced to eliminate false positives for example based on the observation that a function ID is 4 bytes and each parameter is a multiple of 32 bytes. Therefore, the length of the input data should be 32x+4, x>0, if a transaction is used to invoke a non-fallback function. In this example, the analysis engine unit 130 extracts activity characteristics (e.g., invocation function IDs in a transaction and in a dispatch routine of a smart contract, the length of the input data) from the runtime information. By using rules related to execution parameters (e.g., function ID and the length of the input data), the analysis engine unit 130 can identify the “incorrect function invocation”, and generate the analytical data indicating a potential abnormal operation due to the “incorrect function invocation” attack. In this example, the analysis engine unit 130 needs transaction information, because transactions can deploy or invoke smart contracts.

As another example for the set of rules, after invoking a smart contract, the return value should be checked because the callee may halt abnormally due to an exception and the exception produced in the callee will not propagate to the caller. Without checking the return value, the caller does not know whether the execution of the callee is successful, and hence the failure of the callee may cause unexpected issues to the caller. It can be referred as “no check after contract invocation”. The analysis engine unit 130 obtains the bytecode of smart contracts and scans the bytecode to find a check after each contract invocation. If the analysis engine unit 130 cannot find a check, a report is generated. For example, the analysis engine unit 130 detects the problem of lacking a check after a contract invocation, if the instruction sequence after calling a contract cannot match any instruction patterns for checking the return value. In this example, the analysis engine unit 130 extracts activity characteristics (e.g., instruction sequence after contract invocation) from the runtime information. By using rules related to execution orders (e.g., instruction pattern), the analysis engine unit 130 can identify “no check after contract invocation”, and generate the analytical data indicating a potential abnormal operation due to the “no check after contract invocation” attack. In this example, the analysis engine unit 130 needs transaction information to obtain the bytecode of smart contracts.

It should be understood that the above examples for the set of rules are exemplary only and not limiting. For example, the analysis engine unit 130 can identify potential attacks on smart contracts by using any combination of rules

In a further embodiment, the analysis engine unit 130 may determine contents of the runtime information that are required to generate the analytical data. The information collecting unit 112 may obtain the runtime information based on the determined contents. In an example, the information collecting unit 112 may obtain a first message from the analysis engine unit 130 indicating contents of the runtime information that are required to generate the analytical data. In another example, the information collecting unit 112 may obtain the first message from a manager 140 optionally included in the RE 102 indicating contents of the runtime information that are required to generate the analytical data. The manager 140 is responsible for registering and unregistering the analysis engine unit 130. To register an analysis engine unit, a registration message carrying the information about what runtime information is needed by the analysis engine unit and when (i.e., from which block) to apply the analysis engine unit, and which functions are used to receive different runtime information, should be sent to the manager 140 from the analysis engine unit 130 or another device. After receiving the registration message, the manager 140 informs the information collecting unit 112 about what and when runtime information should be sent to the analysis engine unit 130, and which functions of the analysis engine unit are ready for receiving the runtime information. To unregister an analysis engine unit, an unregistration message carrying the information about which analysis engine unit will be unregistered, and when (i.e., from which block) to stop the analysis engine unit, should be sent to the manager from the analysis engine unit or another input. The analysis engine unit will be unregistered immediately, if the information about when to stop is not given. After receiving the unregistration message, the manager 140 deletes the record about the analysis engine unit 130, and then informs the information collecting unit 112 about when to stop sending runtime information to the analysis engine unit. On-demand information retrieval is provided based on the fact that the analysis engine unit 130 may just need partial information to fulfill its functionality, thus reducing high overhead incurred by obtaining and sending all runtime information to the analysis engine unit 130. For example, to prevent smart contracts with reentrancy vulnerabilities being exploited as described above, the analysis engine unit 130 just needs transaction information, and thus on-demand information retrieval does not need to collect the information of blocks and executed RE (e.g., VM) instructions. Therefore, the developers of an analysis engine unit just need to tell the interpreter 110 or the manager 140 what runtime information is needed and how to do if an attack is detected. Therefore, the modification of RE 102 is not needed to develop an analysis engine unit based on the interpreter 110, which is essential to fast response (i.e., fast development of new analysis engine units) to new attacks.

In a further embodiment, the analysis engine unit 130 may determine grouping pattern of the runtime information and groups of the runtime information that are required to generate the analytical data. The information collecting unit 112 may obtain and group the runtime information based on the determined grouping pattern and groups, and the analysis engine unit 130 may generate the analytical data based on the grouped runtime information. In an example, the information collecting unit 112 may obtain a second message from the analysis engine unit 130 indicating grouping pattern of the runtime information and groups of the runtime information that are required to generate the analytical data. In another example, the information collecting unit 112 may obtain the second message from a manager 140 optionally included in the RE 102 indicating grouping pattern of the runtime information and groups of the runtime information that are required to generate the analytical data. After receiving the second message, the information collecting unit 112 may obtain and group the runtime information based on the second message. This can ease analysis engine unit development, because analysis engine unit developers need to know instruction semantics if the analysis engine unit requires the runtime information of RE instructions. With information grouping, analysis engine developers just need to know what kind of information is required, rather than which RE instructions contain the required information. For example, if the analysis engine unit 130 requires the runtime information of comparison instructions, with information grouping, the analysis engine unit 130 just needs to tell the manager 140 or the information collecting unit 112 that “it needs the runtime information of comparison”. However, without information grouping, the analysis engine unit 130 needs to inform the manager 140 that it needs the runtime information of LT, GT, SLT, SGT, EQ, ISZERO which are the comparison instructions supported by EVM for example. Further, the analysis engine unit 130 can flexibly configure the information grouping pattern to protect a single attack or combinations of attacks.

In a further embodiment, the first operation may comprise at least one of creation, deployment, invocation and execution of the smart contract.

In a further embodiment, the second operation may comprise at least one of: permission of one or more activities of the first operation; prevention of one or more activities of the first operation; and generation of a report for one or more activities of the first operation, etc. The responding unit 113 may take action (e.g., security action) according to the analytical data from the analysis engine unit 130 to protect the smart contract against potential attacks. For example, there are three occasions, but embodiments of the disclosure are not limited in this context. First, the responding unit 113 takes no special action and just permit one or more activities of the first operation (e.g., it lets the smart contract(s) run as usual), if the analysis engine unit 130 does not find any attacks based on the analytical data. Second, the responding unit 113 prevents one or more activities of the first operation (e.g., it halts the execution of the smart contract(s)), if the analysis engine unit 130 finds the attacks which will incur serious consequences based on the analytical data. For example, the execution of a smart contract will be stopped if its re-entrancy vulnerability is under attack, because such attack incurs money loss. Third, the responding unit 113 generates a report for one or more activities of the first operation and let the smart contract(s) run, if the analysis engine unit 130 detects an anomaly which may not incur serious consequences based on the analytical data. For example, a miner may control the result of a comparison, if the timestamp of a block is used in the comparison, because the timestamp is set by the miner. Such problem may not cause severe security consequences, so the corresponding analysis engine unit 130 can inform the interpreter 110 to show a report (e.g., a warning message).

In a further embodiment, the RE 102 may optionally include a diagnoser 150 to diagnose or debug the smart contract(s) using the generated report if the second operation comprises generation of the report for one or more activities of the first operation.

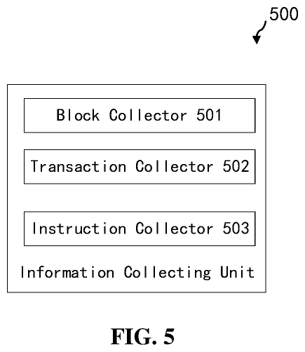

In a further embodiment, the runtime information may include at least one of block information, transaction information and instruction information associated with the first operation. This allows development of arbitrary analysis engine units, because complete runtime information of blocks, transactions and smart contracts can be collected. For example, the information collecting unit 112 can obtain data from any or all fields of each block, data from any or all fields of each transaction, and data from runtime information of any or all executed RE (e.g., VM) instructions. An example of the information collecting unit will be described below in detail with reference to FIG. 5.

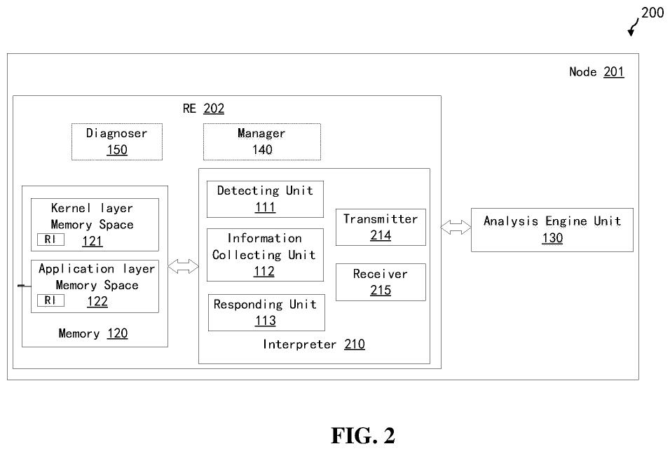

FIG. 2 is a diagram illustrating an architecture 200 for protecting smart contracts against attacks according to an embodiment of the disclosure. As shown in FIG. 2, a node 201 of the architecture 200 has almost the same elements as the node 101 of the architecture a100 except that a running environment (RE) 202 of the node 201 includes an interpreter 210 having a transmitter 214 and a receiver 215. Detailed descriptions of these same elements of FIG. 2 as those of FIG. 1 will be omitted for brevity.

The transmitter 214 transmits the runtime information to an analysis engine unit 130 outside the RE 202.

The receiver 215 receives, from the analysis engine unit 130, analytical data associated with the security of the smart contract resulting from activities of the first operation.

By using rich runtime information as raw data, the architecture 200 described above can provide a general-purpose framework to identify any potential abnormal operation due to attacks to smart contracts on any blockchains and take respective security action to protect the smart contract against attacks. Further, it can reduce difficulty to develop analysis engine units for identifying the potential abnormal operation due to attacks.

In a further embodiment, the information collecting unit 112 or the receiver 215 may obtain a first message indicating contents of the runtime information that are required to be transmitted to the analysis engine unit 130. The information collecting unit 112 may obtain the runtime information based on the first message. Similar to the architecture 100, the first message may be obtained from the analysis engine unit 130 or a manager 140 or another device.

In a further embodiment, the information collecting unit 112 or the receiver 215 may obtain a second message indicating grouping pattern of the runtime information and groups of the runtime information that are required to be transmitted to the analysis engine unit 130. The information collecting unit 112 may obtain and group the runtime information based on the second message and the transmitter 214 may transmit the grouped runtime information to the analysis engine unit 130. Similar to the architecture 100, the second message may be obtained from the analysis engine unit 130 or a manager 140 or another device.

Here, the first operation and the second operation are analogous to those described with respect to FIG. 1.

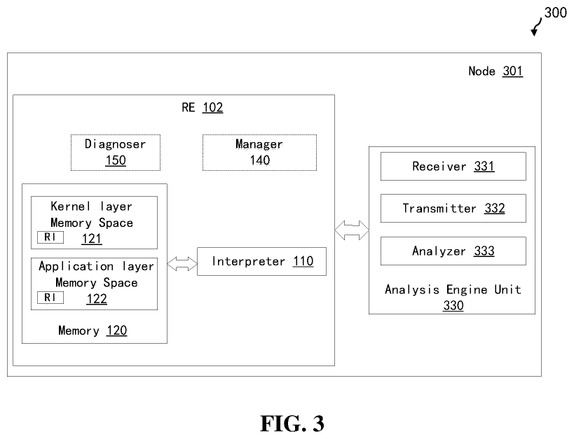

FIG. 3 is a diagram illustrating another architecture 300 for protecting smart contracts against attacks according to an embodiment of the disclosure. As shown in FIG. 3, a node 301 of the architecture 300 has almost the same elements as the node 101 of the architecture 100 except that an analysis engine unit 330 of the node 301 has a receiver 331, a transmitter 332 and an analyzer 333. Detailed descriptions of these same elements of FIG. 3 as those of FIG. 1 will be omitted for brevity.

The receiver 331 receives, from the interpreter 110 in the running environment 102, runtime information as raw data, associated with a first operation that is initiated in the running environment 102 and related to a smart contract on a blockchain.

The analyzer 333 analyzes the runtime information according to a set of rules to generate analytical data associated with the security of the smart contract resulting from activities of the first operation.

The transmitter 332 transmits the analytical data to the interpreter 110.

By using rich runtime information as raw data, the architecture 300 described above can provide a general-purpose framework to identify any potential abnormal operation due to attacks to smart contracts on any blockchains so as to take respective security action to protect the smart contract against attacks. Since the analysis engine 330 is separate from the RE 302, the developers of analysis engine units do not need to understanding blockchain internals because they do not need to modify RE, and therefore developing analysis engine units based on the interpreter is much easier than developing from scratch.

In a further embodiment, the analyzer 333 may extract activity characteristics of the first operation from the runtime information and analyze the activity characteristics according to the set of rules to generate the analytical data, wherein the set of rules are related to at least one of execution orders, the number of executions, and execution parameters, etc.

In a further embodiment, the transmitter 332 may transmit to the interpreter 110 a first message indicating contents of the runtime information that are required to be received from the interpreter 110. The interpreter 110 may transmit the runtime information to the analysis engine unit 330 based on the first message.

In a further embodiment, the transmitter 332 may transmit to the interpreter 110 a second message indicating grouping pattern of the runtime information and groups of the runtime information that are required to be received from the interpreter 110. The interpreter 110 may group the runtime information based on the second message and transmit the grouped runtime information to the analysis engine unit 330.

Here, the first operation and the second operation are analogous to those described with respect to FIG. 1.

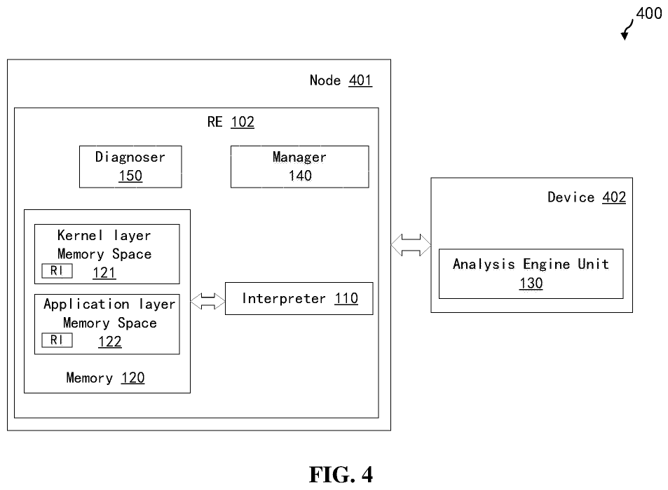

FIG. 4 is a diagram illustrating another architecture 400 for protecting smart contracts against attacks according to an embodiment of the disclosure. As shown in FIG. 4, the architecture 400 has almost the same elements as the architecture 100 except that a RE 102 and an analysis engine unit 130 of the architecture 400 respectively operate on a node 401 and a device 403 separate from the node 401. Detailed descriptions of these similar elements of FIG. 4 as those of FIG. 1 will be omitted for brevity.

The architecture 400 can reduce the processing load of the node 401 with both limited processing capability and power supply. For example, the node 401 may not have the ability to implement complex analysis for potential attacks due to limited resources on the node and thus send the runtime information to an analysis engine unit 430 executing on a device 403 which is sufficient to implement the analysis of the runtime information to generate the analytical data.

Here, the first operation and the second operation are analogous to those described with respect to FIG. 1.

FIG. 5 illustrates an example 500 of an information collecting unit of FIGS. 1-2. The information collecting unit 500 includes a block collector 501, a transaction collector 502 and an instruction collector 503 for obtaining block information, transaction information and instruction information respectively.

The block collector 501 can obtain data from any or all fields of each block. Table 1 below illustrates exemplary block information for the block. A block includes a block header and a block body. The block header contains metadata such as the block number, the difficulty to mine the block, the miner who produces the block, the timestamp when the block was mined, etc. The block body contains the transaction hashes of all external transactions in that block.

TABLE 1
block information

| Block Header | Block Body |
|---|---|
| block number | transaction hashes of all |
| the difficulty to mine the block | external transactions in the |
| the miner who produces the block | block |
| the timestamp when the block was mined | |

The transaction collector 502 can obtain data from any or all fields of each transaction, including each external transaction and each internal transaction. Tables 2A and 2B below illustrate exemplary transaction information of the external transaction and the internal transaction respectively. An external transaction carries much useful information, e.g., the addresses of the transaction sender and the transaction receiver, the amount of resource (e.g., cryptocurrency such as ETH of Ethereum) to send, and the input data. The input data contains the bytecode of a smart contract, if the transaction is used to deploy the smart contract. The input data contains the function ID indicating which function should be invoked, and function parameters, if the transaction is used to call a function in a smart contract. An internal transaction also carries much useful information, e.g., the bytecode of the smart contract to be created, the amount of resource (e.g., cryptocurrency such as ETH of Ethereum) to send, the input data including the function ID of the function to be invoked and the parameters to call a smart contract.

TABLE 2A
transaction information of external transaction

| Type | Information |
|---|---|
| external | the addresses of the transaction sender and the |
| transaction | transaction receiver |
| | the amount of resource (e.g., cryptocurrency |
| | such as ETH of Ethereum) to send |
| | the input data (e.g., the bytecode of the smart |
| | contract to be deployed, the function ID indicating |
| | which function should be invoked, and function |
| | parameters) |

TABLE 2B
transaction information of internal transaction

| Type | Information |
|---|---|
| internal | the bytecode of the smart contract to be created |
| transaction | the amount of resource (e.g., cryptocurrency such |
| | as ETH of Ethereum) to send |
| | the input data (e.g., the function ID of the function |
| | to be invoked and the parameters to call a smart |
| | contract) |

The instruction collector 503 can obtain data from the runtime information of any or all executed RE (e.g., VM) instructions. Table 3 below illustrates exemplary instruction information for different types of instruction. As an example, the name of the field, the location in the field to be read and the read value may be obtained if an instruction reads a field of a block, a transaction or the executed smart contract. As another example, the original balance and the new balance may be obtained if an instruction changes the balance of an account. As yet another example, the stack items consumed by an instruction, and the stack items added by the instruction may be obtained if the instruction consumes the top two stack items, adds the two items and pushes the result on the stack top.

TABLE 3
instruction information

| Type | Information |
|---|---|
| an instruction to read a field of | the name of the field, the |
| a block, a transaction or the | location in the field to be |
| executed smart contract | read and the read value |
| an instruction to change the | the original balance and |
| balance of an account | the new balance |
| an instruction to use the stack | stack items and operations |
| | (e.g., push or pop operation) |
| | on the stack items |

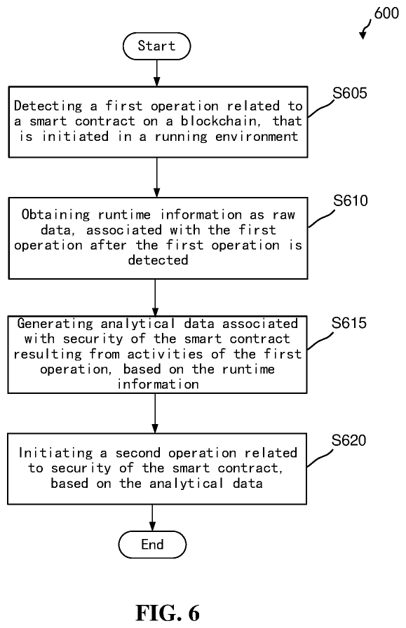

FIG. 6 is a flowchart illustrating an example method 600 for protecting smart contracts against attacks. The method 600 can be implemented by the architecture 100 (including an analysis engine unit 130 and an interpreter 110) of FIG. 1, or the architecture 400 (including an analysis engine unit 430 and an interpreter 410) of FIG. 4. The method 600 includes a detecting step S605, an obtaining step S610, a generating step S615 and an initiating step S620.

At step S605, the method 600 detects a first operation related to a smart contract on a blockchain, that is initiated in a running environment. For example, step S605 can be implemented by a detecting unit 111 of FIG. 1.

At step S610, the method 600 obtains runtime information as raw data, associated with the first operation after the first operation is detected. For example, step S610 can be implemented by an information collecting unit 112 of FIG. 1.

At step S615, the method 600 generates analytical data associated with the security of the smart contract resulting from the first operation based on the runtime information. For example, step S615 can be implemented by an analysis engine unit 130 of FIG. 1.

At step S620, the method 600 initiates a second operation related to the security of the smart contract based on the analytical data. For example, step S620 can be implemented by a responding unit 113 of FIG. 1.

By using rich runtime information as raw data, the method 600 described above can provide a general-purpose framework to identify any potential abnormal operation due to attacks to smart contracts on any blockchains and take respective security action to protect the smart contract against attacks. Further, it can reduce difficulty to develop analysis engine units for identifying the potential abnormal operation due to attacks.

The runtime information may be obtained from a kernel layer and an application layer of the running environment.

The method 600 may further include the step of analyzing the runtime information according to a set of rules to generate the analytical data.

The method 600 may further include the steps of: extracting activity characteristics of the first operation from the runtime information, and analyzing the activity characteristics according to the set of rules to generate the analytical data, wherein the set of rules are related to at least one of execution orders, the number of executions, and execution parameters.

The method 600 may further include the steps of: determining contents of the runtime information that are required to generate the analytical data, and obtaining the runtime information based on the determined contents.

The method 600 may further include the steps of: determining grouping pattern of the runtime information and groups of the runtime information that are required to generate the analytical data, obtaining and grouping the runtime information based on the determined grouping pattern and groups, and generating the analytical data based on the grouped runtime information.

The first operation may include at least one of creation, deployment, invocation and execution of the smart contract.

The second operation may include at least one of: permission of one or more activities of the first operation; prevention of one or more activities of the first operation; and generation of a report for one or more activities of the first operation.

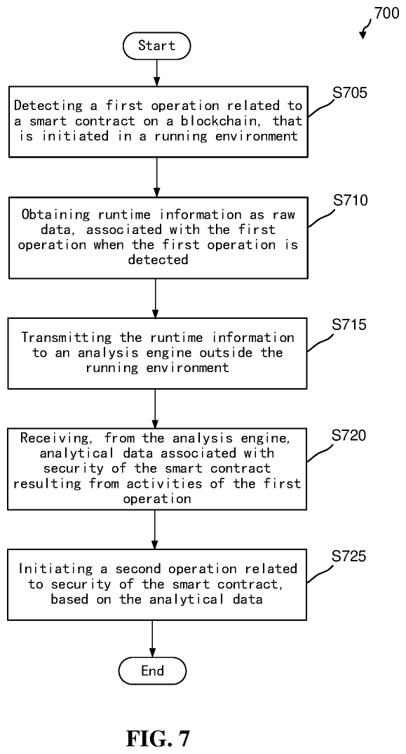

FIG. 7 is a flowchart illustrating an example method 700 for protecting smart contracts against attacks. The method 700 can be implemented by the architecture 200 (including an interpreter 210) of FIG. 2 or the architecture 400 (including an interpreter 110) of FIG. 4. The method 700 includes a detecting step S705, an obtaining step S710, a transmitting step S715, a receiving step S720 and an initiating step S725.

At step S705, the method 700 detects a first operation related to a smart contract on a blockchain, that is initiated in a running environment. Step S705 is similar to step S605 in FIG. 6 and can be implemented by a detecting unit 111 of FIG. 2 for example.

At step S710, the method 700 obtains runtime information as raw data, associated with the first operation after the first operation is detected. Step S710 is similar to step 610 in FIG. 6 and can be implemented by an information collecting unit 112 of FIG. 2 for example.

At step S715, the method 700 transmits the runtime information to an analysis engine unit outside the running environment. For example, step S715 can be implemented by a transmitter 214 of FIG. 2. The transmitter 214 may be included in or implemented by the information collecting unit 112. Alternatively, the transmitter 214 may be implemented separately from the information collecting unit 112.

At step S720, the method 700 receives, from the analysis engine unit, analytical data associated with the security of the smart contract resulting from activities of the first operation. For example, step S720 can be implemented by a receiver 215 of FIG. 2. The receiver 215 may be included in or implemented by a responding unit 113 of FIG. 2. Alternatively, the receiver 215 may be implemented separately from the responding unit 113.

At step S725, the method 700 initiates a second operation related to the security of the smart contract based on the analytical data. Step S725 is similar to step 620 in FIG. 6 and can be implemented by a responding unit 113 of FIG. 2.

By using rich runtime information as raw data, the method 700 described above can provide a general-purpose framework to identify any potential abnormal operation due to attacks to smart contracts on any blockchains and take respective security action to protect the smart contract against attacks. Further, it can reduce difficulty to develop analysis engine units for identifying the potential abnormal operation due to attacks.

The runtime information may be obtained from a kernel layer and an application layer of the running environment.

The method 700 may further include the steps of: obtaining a first message indicating contents of the runtime information that are required to be transmitted to the analysis engine unit; and obtaining the runtime information based on the first message.

The method 700 may further include the steps of: obtaining a second message indicating grouping pattern of the runtime information and groups of the runtime information that are required to be transmitted to the analysis engine unit; obtaining and grouping the runtime information based on the second message; and transmitting the grouped runtime information to the analysis engine unit.

The first operation may include at least one of creation, deployment, invocation and execution of the smart contract.

The second operation may include at least one of: permission of one or more activities of the first operation; prevention of one or more activities of the first operation; and generation of a report for one or more activities of the first operation.

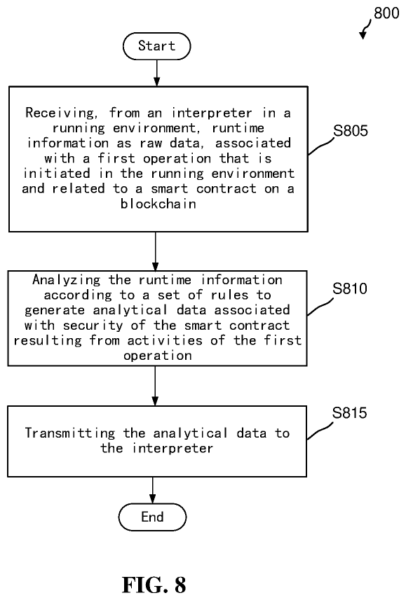

FIG. 8 is a flowchart illustrating an example method 800 for protecting smart contracts against attacks. The method 800 can be implemented by the architecture 300 (including an analysis engine unit 330) of FIG. 3 or the architecture 400 (including an analysis engine unit 130) of FIG. 4. The method 800 includes a receiving step S805, an analyzing step S810 and a transmitting step S815.

At step S805, the method 800 receives, from an interpreter in a running environment, runtime information as raw data, associated with a first operation that is initiated in the running environment and related to a smart contract on a blockchain. For example, step S805 can be implemented by a receiver 331 of FIG. 3.

At step S810, the method 800 analyzes the runtime information according to a set of rules to generate analytical data associated with the security of the smart contract resulting from activities of the first operation. For example, step S810 can be implemented by an analyzer 333 of FIG. 3.

At step S815, the method 800 transmits the analytical data to the interpreter. For example, step S815 can be implemented by a transmitter 332 of FIG. 3.

By using rich runtime information as raw data, the method 800 described above can provide a general-purpose framework to identify any potential abnormal operation due to attacks to smart contracts on any blockchains so as to take respective security action to protect the smart contract against attacks. Further, it can reduce difficulty to develop analysis engine units for identifying the potential abnormal operation due to attacks.

The runtime information may be obtained from a kernel layer and an application layer of the running environment.

The method 800 may further include the steps of: extracting activity characteristics of the first operation from the runtime information; and analyzing the activity characteristics according to the set of rules to generate the analytical data, wherein the set of rules are related to at least one of execution orders, the number of executions, and execution parameters.

The method 800 may further include the step of transmitting to the interpreter a first message indicating contents of the runtime information that are required to be received from the interpreter.

The method 800 may further include the step of transmitting to the interpreter a second message indicating grouping pattern of the runtime information and groups of the runtime information that are required to be received from the interpreter.

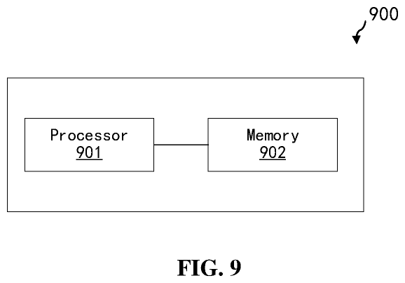

FIG. 9 is a diagram illustrating an example apparatus 900 for protecting smart contracts against attacks. The apparatus 900 may include a processor 901 and a memory 902 coupled to the processor 901. The processor 901 may be a general-purpose processor, a digital signal processor (DSP), an application specific integrated circuit (ASIC), a field programmable gate array (FPGA) or other programmable logic device, discrete gate or transistor logic, discrete hardware components, or any combination thereof. The memory 902 may include random access memory (RAM) and read only memory (ROM). The memory 902 may store computer-readable, computer-executable software including instructions that, when executed, cause the processor 901 to perform various functions described herein (e.g., any or all steps of methods 600, 700 and 800 for protecting smart contracts against attacks, etc.).

The various illustrative blocks and modules described in connection with the disclosure herein may be implemented or performed with a general-purpose processor, a DSP, an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a non-transitory computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A computer-implemented method for protecting a smart contract against attacks, comprising the steps of:
detecting a first operation related to a smart contract on a blockchain, that is initiated in a running environment;
obtaining runtime information as raw data, associated with the first operation after the first operation is detected;
generating analytical data associated with the security of the smart contract resulting from activities of the first operation, based on the runtime information; and
initiating a second operation related to the security of the smart contract, based on the analytical data.

2. The method of claim 1, wherein the runtime information is obtained from a kernel layer and an application layer of the running environment.

3. The method of claim 1, wherein the step of generating the analytical data comprises the step of analyzing the runtime information according to a set of rules to generate the analytical data.

4. The method of claim 3, wherein the step of analyzing the runtime information comprises the steps of:
extracting activity characteristics of the first operation from the runtime information; and
analyzing the activity characteristics according to the set of rules to generate the analytical data, the set of rules being related to at least one of execution orders, the number of executions, and execution parameters.

5. The method of claim 1, further comprising the step of determining contents of the runtime information that are required to generate the analytical data; and
wherein the step of obtaining the runtime information further comprises the step of obtaining the runtime information based on the determined contents.

6. The method of claim 1, further comprising the step of determining grouping pattern of the runtime information and groups of the runtime information that are required to generate the analytical data;
wherein the step of obtaining the runtime information further comprises the step of obtaining and grouping the runtime information based on the determined grouping pattern and groups; and
wherein the step of generating the analytical data further comprises the step of generating the analytical data based on the grouped runtime information.

7. The method of claim 1, wherein:
the first operation comprises at least one of creation, deployment, invocation and execution of the smart contract; and
the second operation comprises at least one of: permission of one or more activities of the first operation; prevention of one or more activities of the first operation; and generation of a report for one or more activities of the first operation.

8. The method of claim 1, wherein the runtime information comprises at least one of block information, transaction information and instruction information associated with the first operation.

9. A computer implemented method for protecting a smart contract against attacks, comprising the steps of:
detecting a first operation related to a smart contract on a blockchain, that is initiated in a running environment;
obtaining runtime information as raw data, associated with the first operation after the first operation is detected;
transmitting the runtime information to an analysis engine unit outside the running environment;
receiving, from the analysis engine unit, analytical data associated with the security of the smart contract resulting from activities of the first operation; and
initiating a second operation related to the security of the smart contract, based on the analytical data.

10. The method of claim 9, wherein the runtime information is obtained from a kernel layer and an application layer of the running environment.

11. The method of claim 9, further comprising the step of obtaining a first message indicating contents of the runtime information that are required to be transmitted to the analysis engine unit; and
wherein the step of obtaining the runtime information further comprises the step of obtaining the runtime information based on the first message.

12. The method of claim 9, further comprising the step of obtaining a second message indicating grouping pattern of the runtime information and groups of the runtime information that are required to be transmitted to the analysis engine unit;
wherein the step of obtaining the runtime information further comprises the step of obtaining and grouping the runtime information based on the second message; and
wherein the step of transmitting the runtime information to an analysis engine unit further comprises the step of transmitting the grouped runtime information to the analysis engine unit.

13. The method of claim 9, wherein:
the first operation comprises at least one of creation, deployment, invocation and execution of the smart contract; and
the second operation comprises at least one of: permission of one or more activities of the first operation; prevention of one or more activities of the first operation; and generation of a report for one or more activities of the first operation.

14. The method of claim 9, wherein the runtime information comprises at least one of block information, transaction information and instruction information associated with the first operation.

15. A computer implemented method for protecting a smart contract against attacks, comprising the steps of:
receiving, from an interpreter in a running environment, runtime information as raw data, associated with a first operation that is initiated in the running environment and related to a smart contract on a blockchain;
analyzing the runtime information according to a set of rules to generate analytical data associated with the security of the smart contract resulting from activities of the first operation; and
transmitting the analytical data to the interpreter.

16. The method of claim 15, wherein the runtime information is obtained from a kernel layer and an application layer of the running environment.

17. The method of claim 15, wherein the step of analyzing the runtime information comprises the steps of:
extracting activity characteristics of the first operation from the runtime information; and
analyzing the activity characteristics according to the set of rules to generate the analytical data, the set of rules being related to at least one of execution orders, the number of executions, and execution parameters.

18. The method of claim 15, further comprising the step of transmitting to the interpreter a first message indicating contents of the runtime information that are required to be received from the interpreter.

19. The method of claim 15, further comprising the step of transmitting to the interpreter a second message indicating grouping pattern of the runtime information and groups of the runtime information that are required to be received from the interpreter.

20. An apparatus for protecting a smart contract against attacks, comprising:
a detecting unit configured to detect a first operation related to a smart contract on a blockchain, that is initiated in a running environment;
an information collecting unit configured to obtain runtime information as raw data, associated with the first operation after the detecting unit detects the first operation;
an analysis engine unit configured to generate analytical data associated with the security of the smart contract resulting from activities of the first operation, based on the runtime information; and
a responding unit configured to initiate a second operation related to the security of the smart contract, based on the analytical data.

21. (canceled)

22. (canceled)

23. (canceled)

24. (canceled)

25. (canceled)

26. An apparatus for protecting a smart contract against attacks, comprising:
a detecting unit configured to detect a first operation related to a smart contract on a blockchain, that is initiated in a running environment;
an information collecting unit configured to obtain runtime information as raw data, associated with the first operation after the detecting unit detects the first operation;
a transmitter configured to transmit the runtime information to an analysis engine unit outside the running environment;
a receiver configured to receive analytical data associated with the security of the smart contract resulting from activities of the first operation from the analysis engine unit; and
a responding unit configured to initiate a second operation related to the security of the smart contract based on the analytical data.

27. (canceled)

28. An apparatus for protecting a smart contract against attacks, comprising:
a receiver configured to receive, from an interpreter in a running environment, runtime information as raw data, associated with a first operation that is initiated in the running environment and related to a smart contract on a blockchain;
an analyzer configured to analyze the runtime information according to a set of rules to generate analytical data associated with the security of the smart contract resulting from activities of the first operation; and
a transmitter configured to transmit the analytical data to the interpreter.

29. (canceled)

30. (canceled)

31. (canceled)

32. (canceled)

33. An apparatus for protecting a smart contract against attacks, comprising:
at least one processor; and
a memory storing instructions, which when executed cause the at least one processor to implement a method according to claim 1.

34. A computer readable storage medium storing computer executable instructions for implementing a method according to claim 1.

35. A computer program product, tangibly stored in a computer readable storage medium, the computer program product storing computer executable instructions, which when executed cause at least one processor to implement a method according to claim 1.
